(19) United States
(12) Patent Application Publication
(10) Pub. No.: US 2010/0038814 A1
(43) Pub. Date: Feb. 18, 2010

(54) Method for Manufacturing Interior Panel of Motor Vehicle

(75) Inventor: Chang Soo Suh, Suwon-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/349,283

(22) Filed: Jan. 6, 2009

(30) Foreign Application Priority Data
Aug. 14, 2008 (KR) 10-2008-0079978

(51) Int. Cl. B29C 45/14

(52) U.S. Cl. 264/161

(57) ABSTRACT

A method of manufacturing a product may include a step of forming an end of a film in a hook shape corresponding to one side cavity of an upper mold, a step of removing an unnecessary portion of the film, a step of inserting the film into the one side cavity in a state that a side having the hook shape in the film is disposed at an inner surface of the upper mold, a step of injecting injection liquid into the one side cavity in a state that the one side cavity is partitioned from the other side cavity of the upper mold, a step of injecting injection liquid into the other side cavity, a step of filling a partitioning portion formed between the one side cavity and the other side cavity to form an injection-molded body, and a step of extracting the injection-molded body.

### CROSS-REFERENCE TO RELATED APPLICATION

The present application claims priority to Korean Patent Application Number 10-2008-0079978 filed Aug. 14, 2008, the entire contents of which application is incorporated herein for all purposes by this reference.

### BACKGROUND OF THE INVENTION

1. Field of the Invention

The present invention relates to an interior panel of motor vehicle, and more particularly, to a method for manufacturing an interior panel of motor vehicle.

2. Description of Related Art

Generally, an interior part is attached to the front of a driver seat or the inside of the door in the indoor room of vehicles, and the interior part plays a role of protecting occupants by shock-absorbing force of polyurethane foam having elasticity which is filled therein in consideration of directly contacting the body of occupants during vehicle accident as well as enhancing esthetic scene of the inside of the vehicle.

Furthermore, various controllers and facilities such as a dash board, an audio deck, a gear lever, an airbag, a door lock, a window opening/closing device, and the like are installed near a driver seat and a front passenger seat, and these controllers and facilities are generally installed to installation holes which are formed by being cut in interior parts such as an instrument panel or a door trim to be exposed to the outside, and an interior part finishing panel for vehicles is provided in a gap between the outside of the various controllers and the facilities and the interior part so as to finish the interior part.

Here, the term of the interior panel of motor vehicle is used to include not only the interior part such as an instrument panel and a door trim, a dash board finishing panel, an audio finishing panel, a gear lever part finishing panel, a window switch finishing panel, but also an interior part finishing panel such as a door scarf which is provided at a lower end of a vehicle body opening part so as not only to effectively prevent a weather strip from moving outside when being stepped by occupants but also to enhance esthetic scene.

Such an interior panel has a great effect on esthetic scene of an interior of a vehicle, so demand for external esthetic requirement is gradually increased under the recent trend of personality of a vehicle.

In a prior art the interior panel is generally made of soft synthetic resin, synthetic resin foam with cushion, or the like, and it is impossible to plate on the surface of such materials, so there is a problem in that it is difficult to print various shape thereon and therefore there is a limitation in enhancing esthetic scene.

Accordingly, in order to solve this problem, an interior panel which is formed by a thin film called as the wood grain has been recently developed so as to enhance esthetic scene of the surface.

The wood grain is formed by painting wood grain chemical special paint on the surface thereof having the pattern which is substantially equal to the pattern of wood, and can show the same color and pattern, or wood grain on the surface thereof so as to enhance esthetic scene in the interior of the vehicle. However, the wood grain only provides the material feel similar to wood but not provide unique design feel so that occupants can easily have a bellyful of the same.

As such, in a prior interior panel for vehicles, in case of being formed by soft synthetic resin or synthetic resin foam with cushion, it is impossible to plate soft material with chrome so that there is a drawback that interior mood and design feel cannot be enhanced, and in case of applying the wood grain, the wood grain only provides the material feel similar to the original wood but not provide unique design feel so that it is impossible to meet with various design preference and desire.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a method of manufacturing an interior panel of motor vehicle in which the film is integrated so as to make various moods and to provide a method of manufacturing an interior panel of motor vehicle in which one end of the film is made not to be exposed.

In an aspect of the present invention, a method of manufacturing a product, may include a film forming step of forming an end of a film in a hook shape corresponding to one side cavity of an upper mold, a trimming step of removing an unnecessary portion formed at the end of the film, a film inserting step of inserting the film into the one side cavity of the upper mold in a state that a side having the hook shape in the film is disposed at an inner surface of the upper mold, a first filling step of injecting injection liquid into the one side cavity in a state that the one side cavity is partitioned from the other side cavity of the upper mold, a second filling step of injecting injection liquid into the other side cavity of the upper mold, a partitioning portion filling step of filling a partitioning portion formed between the one side cavity and the other side cavity of the upper mold to form an injection-molded body integrated by the film and the solidified injection liquid, and/or an injection-molded body extracting step of extracting the injection-molded body.

The product may be an interior panel of a motor vehicle.

In the film forming step, the film may be formed through a vacuum thermal forming on a jig, wherein the jig has a predetermined curvature to form the hook shape for the film.

In the film inserting step, the end of the film in the hook shape may extend to the one side cavity sufficiently enough to be submerged therein.

In the first filling step, the one side cavity and the other side cavity may be partitioned by disposing an operating core therebetween.

In the partitioning portion filling step, an operating core disposed between the one side cavity and the other side cavity may be removed from therebetween before the injection liquid injected into the other side cavity at the second filling step is hardened.

In the injection-molded body extracting step, the injection-molded body is separated from a lower mold by moving an operating core through the lower mold.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a flowchart showing an exemplary method of manufacturing interior panel of motor vehicle according to the present invention.

FIG. 2 is a drawing for explaining a film forming step of FIG. 1.

FIG. 3 is a drawing for explaining a trimming step of FIG. 1.

FIG. 4 is a drawing for explaining a film inserting step of FIG. 1.

FIG. 5 is a drawing for explaining a first filling step of FIG. 1.

FIG. 6 is a drawing for explaining a second filling step of FIG. 1.

FIG. 7 and FIG. 8 are drawings for explaining a partitioning portion filling step of FIG. 1.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

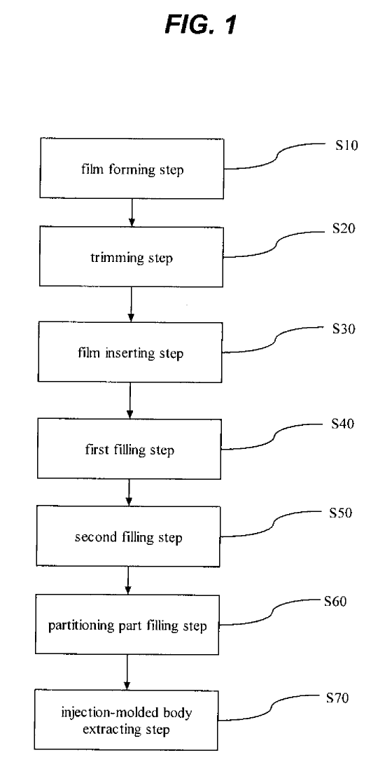

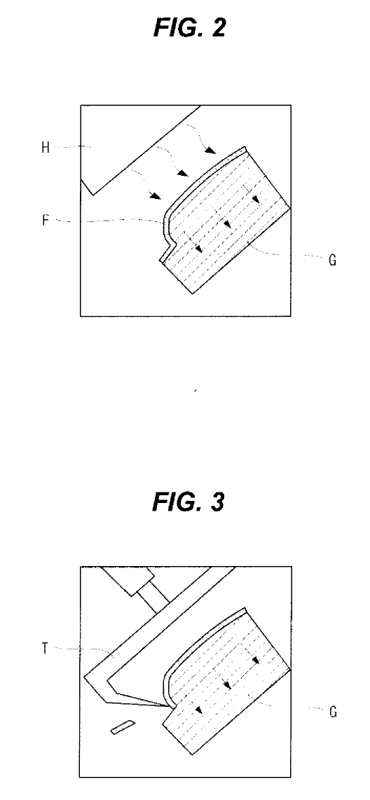

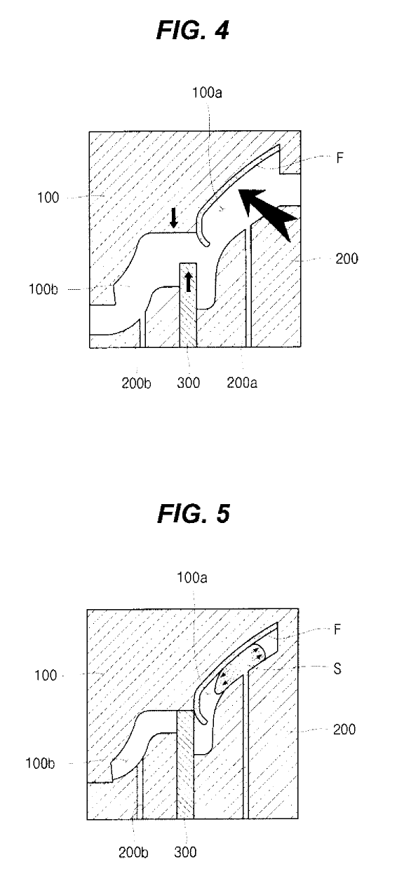

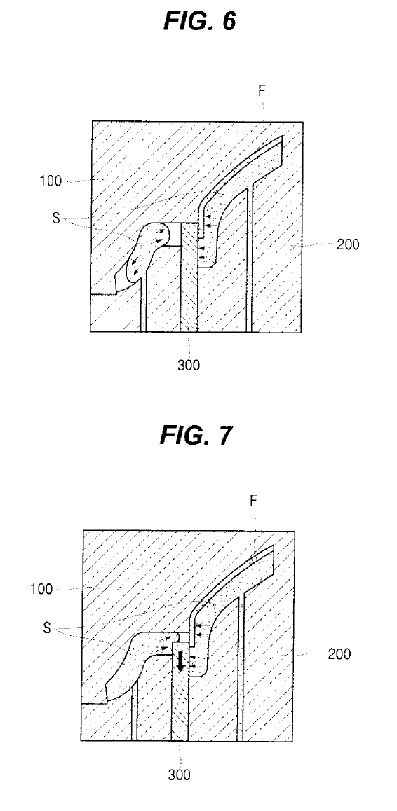

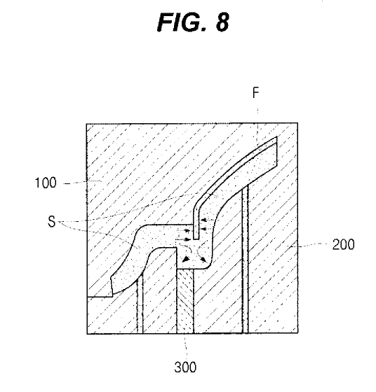

FIG. 1 is a flowchart showing a method of manufacturing interior panel of motor vehicle according to an exemplary embodiment of the present invention, FIG. 2 is a drawing for explaining a film forming step of FIG. 1, FIG. 3 is a drawing for explaining a trimming step of FIG. 1, FIG. 4 is a drawing for explaining a film inserting step of FIG. 1, FIG. 5 is a drawing for explaining a first filling step of FIG. 1, FIG. 6 is a drawing for explaining a second filling step of FIG. 1, and FIG. 7 and FIG. 8 are drawings for explaining a partitioning portion filling step of FIG. 1.

As shown in FIG. 1, a method of manufacturing a interior panel of motor vehicle according to an exemplary embodiment of the present invention includes a film forming step S10, a trimming step S20, a film inserting step S30, a first filling step S40, a second filling step S50, a partitioning portion filling step S60, and an injection-molded body extracting step S70.

The film forming step S10, as shown in FIG. 2, forms a film F through a thermal forming with a heater H on a jig C in a state of vacuum, and forms an end portion in a hook shape corresponding to a one side cavity 100a of an upper mold 100.

The trimming step S20, as shown in FIG. 3, removes an unnecessary portion of an end of the film F on the jig G with a trim device T.

The film inserting step S30, as shown in FIG. 4, is a step of inserting the film F into the one side cavity 100a of the upper mold 100 in a state that the side with the hook shape is disposed at an inside.

In addition, cavity areas 100a and 100b are partitioned at the step S30 before the first filling step S40, and this is performed by rising of an operating core 300 which is slidable upwards and downwards through a lower mold 200 between the cavity areas 100a and 100b.

The first filling step S40, as shown in FIG. 5, is a step of injecting injection liquid S on the one side cavity 100a in a state that the one side cavity 100a and the other side cavity 100b of the upper mold 100 are partitioned from one another.

For this, a first injection hole 200a which communicates with the one side cavity 100a is penetrated on one side of the lower mold 200.

As such, if the insertion of the injection liquid S on the one side cavity 100a is completed, the portion with the hook shape of the film F is straightly spread in a downward direction by the injection liquid S in a state of surface-contacting the side of the operating core 300.

The second filling step S50, as shown in FIG. 6, is a step of injecting the injection liquid S into the other side cavity 100b of the upper mold 100.

For this, a second injection hole 200b which communicates with the other side cavity 100b is penetrated on the other side of the lower mold 200.

The partitioning portion filling step S60, as shown in FIG. 7 and FIG. 8, is a step of filling the partitioning portion formed due to the operating core 300 between the one side cavity 100a and the other side cavity 100b of the upper mold 100.

As such, the partitioning portion of the cavity areas 100a and 100b is removed by descent of the operating core 300 and filled with injection liquid S. Since the partitioning portion is filled until internal pressures in the both cavities areas 100a and 100b make equilibrium, the end part of the film is uniformly formed to be sealed between filling liquid.

Further since the one side cavity 100a is disposed higher than the other side cavity 100b, the end of the film F can be sufficiently submerged into the injection liquid S.

The injection-molded body extracting step S70 is a step of extracting an injection-molded body which is formed by integration of the film and the solidified injection liquid. In an exemplary embodiment of the present invention, the operating core 300 may move upwards again so that the injection-molded body can be extracted from the lower mold 200 after the upper mold 100 is lifted at first.

By the above-mentioned processes (steps S10 to S70), one end (the side with the hook shape) is not exposed but is finished to be inserted inside the injection-molded body.

As mentioned above, according to a method of manufacturing a interior panel of motor vehicle according various aspects of to the present invention, the film with various material and shape can be selectively used on the interior panel so as to variously meet with esthetic demands of the user and since one end of the film is not exposed but is disposed to be inserted in the filling liquid, finishing can be sleekly performed.

Furthermore, since one end of the film is not exposed but is disposed to be inserted in the filling liquid, finishing can be sleekly performed.

For convenience in explanation and accurate definition in the appended claims, the terms “upper”, “lower”, “upwards”, and “downwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of manufacturing a product, comprising:
a film forming step of forming an end of a film in a hook shape corresponding to one side cavity of an upper mold;
a trimming step of removing an unnecessary portion formed at the end of the film;
a film inserting step of inserting the film into the one side cavity of the upper mold in a state that a side having the hook shape in the film is disposed at an inner surface of the upper mold;
a first filling step of injecting injection liquid into the one side cavity in a state that the one side cavity is partitioned from the other side cavity of the upper mold;
a second filling step of injecting injection liquid into the other side cavity of the upper mold;
a partitioning portion filling step of filling a partitioning portion formed between the one side cavity and the other side cavity of the upper mold to form an injection-molded body integrated by the film and the solidified injection liquid; and
an injection-molded body extracting step of extracting the injection-molded body.

2. The method of claim 1, wherein the product is an interior panel of a motor vehicle.

3. The method of claim 1, wherein in the film forming step, the film is formed through a vacuum thermal forming on a jig.

4. The method of claim 3, wherein the jig has a predetermined curvature to form the hook shape for the film.

5. The method of claim 1, wherein in the film inserting step, the end of the film in the hook shape extends to the one side cavity sufficiently enough to be submerged therein.

6. The method of claim 1, wherein in the first filling step, the one side cavity and the other side cavity are partitioned by disposing an operating core therebetween.

7. The method of claim 1, wherein in the partitioning portion filling step, an operating core disposed between the one side cavity and the other side cavity is removed from therebetween before the injection liquid injected into the other side cavity at the second filling step is hardened.

8. The method of claim 1, wherein in the injection-molded body extracting step, the injection-molded body is separated from a lower mold by moving an operating core through the lower mold.
